(19) United States
(12) Patent Application Publication
(10) Pub. No.: US 2003/0226055 A1
(43) Pub. Date: Dec. 4, 2003

(54) Controller of electronic equipment and clock skew adjusting method

(75) Inventor: Michio Yoshitake, Nagano-ken (JP)

Correspondence Address: SUGHRUE MION, PLLC, 2100 Pennsylvania Avenue, NW, Washington, DC, 20037-3213, US

(73) Assignee: SEIKO EPSON CORPORATION

(21) Appl. No.: 10/382,468

(22) Filed: Mar. 6, 2003

(30) Foreign Application Priority Data
Mar. 12, 2002 (JP) 2002-067119

(51) Int. Cl. G06F 1/04

(52) U.S. Cl. 713/503

(57) ABSTRACT

A CPU 30 reads out SPD information of an installed RAM module 60 and obtains a memory capacity of the RAM module 60. Information about clock adjusted values corresponding to the memory capacity is stored in the ROM 50 and the CPU 30 controls a phase adjuster in accordance with the information. As a result, a skew-adjusted clock is entered into the RAM module 60. Thus, in the controller of the electronic equipment, a clock skew to be supplied to the RAM module can easily be adjusted.

### TECHNICAL FIELD

The present invention relates to a controller of an electronic equipment such as a printer, and more particularly to a technique of adjusting a clock skew in correspondence with a load of a RAM module.

### BACKGROUND ART

Chips such as CPU, RAM, and memory controller, installed in a controller (main board) which is mounted in an electronic equipment such as a printer for controlling the electronic equipment, are to do the respective processing in synchronization with a clock generated by an oscillator.

FIG. 5 is a block diagram for explaining one example of the configuration related to a clock, of the conventional controller. In this example, it is assumed that the controller is provided with two RAM sockets; and a RAM module 160a and a RAM module 160b are installed in the two RAM sockets, respectively.

As illustrated in this figure, a clock generated by an oscillator 110 is supplied to a CPU 130, a memory controller 140, the RAM module 160a, and the RAM module 160b, through clock drivers 120a to 120d. The CPU 130, the memory controller 140, the RAM module 160a, and the RAM module 160b operate in synchronization with this clock so as to transfer each signal.

In this synchronous design, there occurs a timing deviation, which is so-called a clock skew, caused by a difference of the propagation delay of a clock, a difference of load capacity of each chip, wiring capacity, and the like. FIG. 4A is a view indicating that the timing of a clock supplied to each chip is deviated owing to the clock skew. In this figure, the CLK3 supplied to the RAM module 160a is most delayed. When this clock skew becomes large, it has an ill effect on signal transfer between chips, and therefore, it is necessary to adjust the wiring length of each clock signal line to align the arrival time of the clock to each chip.

Among these chips, the specifications of the CPU 130 and the memory controller 140 have been already determined and after the shipment, they will never be changed. Therefore, it is easy to adjust the skew by changing the wiring length of each clock signal line and the like.

As for the RAM module 160 composed of a plurality of memory chips, however, what kind of RAM module to be installed is not determined yet at a development time in many cases. Also after the shipment, it may be often replaced with the RAM module having different memory capacity. Generally, since the load capacity of the RAM module varies depending on the memory capacity (how many memory chips the RAM module consists of), it is impossible to estimate the clock skew caused by load capacity at the development time and it is difficult to adjust the skew of the RAM module 160 by changing the wiring length of each clock signal line and the like.

### DISCLOSURE OF THE INVENTION

The invention aims to enable easy adjustment of a clock skew about the RAM module in a controller of an electronic equipment such as a printer.

A controller provided by the invention in order to solve the above problem is

a controller for controlling a printer, comprising

an oscillator for generating a clock,

a CPU that is a destination of the clock and a RAM socket to which a RAM module that is a destination of the clock is attached,

a ROM which stores information for controlling the controller, and

an adjuster for adjusting a timing of the clock to be supplied to the RAM module attached to the RAM socket, wherein

the CPU obtains information about the RAM module from the RAM module attached to the RAM socket, and

controls the adjuster, in accordance with an adjusted value of the clock to be supplied to the RAM module, which is determined by the obtained information about the RAM module and the information stored in the ROM, so as to adjust the timing of the clock to be supplied to the RAM module.

According to the present invention, even if the RAM module to be installed is changed, the clock timing can be adjusted by the adjuster. Therefore, the clock skew about the RAM module can easily be adjusted.

Here, the information about the RAM may include a memory capacity of the RAM module, and

the information stored in the ROM may include the information in which a memory capacity of the RAM module is brought into correspondence with the adjusted value of the clock to be adjusted.

Further, the adjusted value of the clock can be represented by a phase or delay time of a clock.

When the controller is provided with a plurality of the RAM sockets, the timing adjustment of a clock to be supplied to the RAM module is performed on each RAM module installed in a plurality of the RAM sockets.

A method for adjusting a clock skew provided by the invention in order to solve the above problem is a method for adjusting the clock skew caused by a difference of the respective load capacities of a plurality of chips operated in synchronization with a clock, characterized by comprising

a step of obtaining the information corresponding to the load capacity of a chip whose skew is to be adjusted, and

a step of adjusting a phase of a clock to be supplied to the chip, in accordance with the obtained information corresponding to the load capacity.

Here, the chip whose skew is to be adjusted may be the RAM module.

At this time, when there are a plurality of the RAM modules, the skew may be adjusted for each RAM module.

The present invention further provides a controller for controlling an electronic equipment, comprising

an oscillator for generating a clock,

a CPU that is a destination of a clock and a RAM socket for installing a RAM module that is a destination of a clock,

a ROM which stores information for controlling the controller, and

an adjuster for adjusting a timing of the clock to be supplied to the RAM module installed in the RAM socket, wherein

the CPU obtains information about the RAM module from the RAM module installed in the RAM socket, and

controls the adjuster, in accordance with an adjusted value of the clock to be supplied to the RAM module, which is determined by the obtained information about the RAM module and the information stored in the ROM, so as to adjust the timing of the clock to be supplied to the RAM module.

### BRIEF DESCRIPTION OF THE DRAWINGS

FIG. 1 is a block diagram describing the configuration related to a clock, of a controller to which the invention is applied.

FIG. 2 is a view describing one example of the configuration of the RAM module 60.

FIG. 3 is a flow chart describing an operation of the controller in this embodiment.

FIGS. 4A and 4B are a view showing each clock to be supplied to each chip; FIG. 4A indicates that a clock is deviated owing to the load capacity of the RAM module, and FIG. 4B indicates that the clock to be supplied to the RAM module has been adjusted according to the invention.

FIG. 5 is a block diagram describing one example of the configuration related to a clock, of the conventional controller.

### BEST MODE FOR CARRYING OUT THE INVENTION

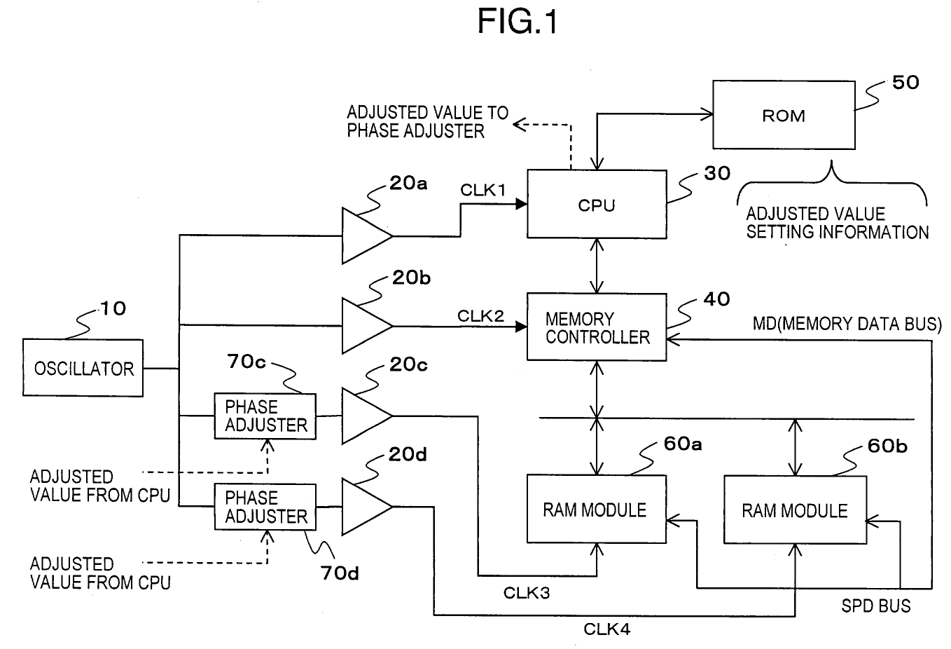

An embodiment of the invention will be described with reference to the drawings. FIG. 1 is a block diagram describing the configuration related to a clock, of a controller to which the invention is applied. The controller is, for example, installed in a printer, so that the printing operation of the printer can be controlled by the CPU's processing in accordance with a program stored in a ROM 50.

In this embodiment, the controller comprises an oscillator 10, where a clock of a predetermined frequency, for example, the clock of 100 MHz is generated. As a destination of this clock, a CPU 30, a memory controller 40, and a RAM module 60a and a RAM module 60b installed in two RAM sockets are provided on the controller. However, the destination of the clock is not restricted to the above chips, and the numbers of the RAM sockets and the RAM modules are not restricted to two.

Data is exchanged between the memory controller 40 and the respective RAM modules 60a and 60b through a memory data bus.

To the CPU 30 the ROM 50 is connected which operates asynchronously to the CPU 30, the memory controller 40, and the like. Stored in the ROM 50 is, not only a program and the like for controlling the operation of the controller but also the information for adjusting a phase of a clock supplied to the RAM module 60, depending on the type of the RAM module 60 installed in the controller. This information will be described later.

In this embodiment, a clock is supplied to the CPU 30 and the memory controller 40 through clock drivers 20a and 20b. Clocks phase-adjusted by phase adjusters 70c and 70d are supplied respectively to the RAM module 60a and the RAM module 60b through clock drivers 20c and 20d.

The phase adjusters 70c and 70d are the devices for outputting a clock after arbitrarily changing the phase of the clock received from the oscillator 10. As the phase adjuster, for example, those of the PLL method, octave band method, frequency conversion method, and the like are representative. The invention can adopt any method.

The phases to be adjusted are individually set in the respective phase adjusters 70c and 70d in accordance with a control signal sent from the CPU 30.

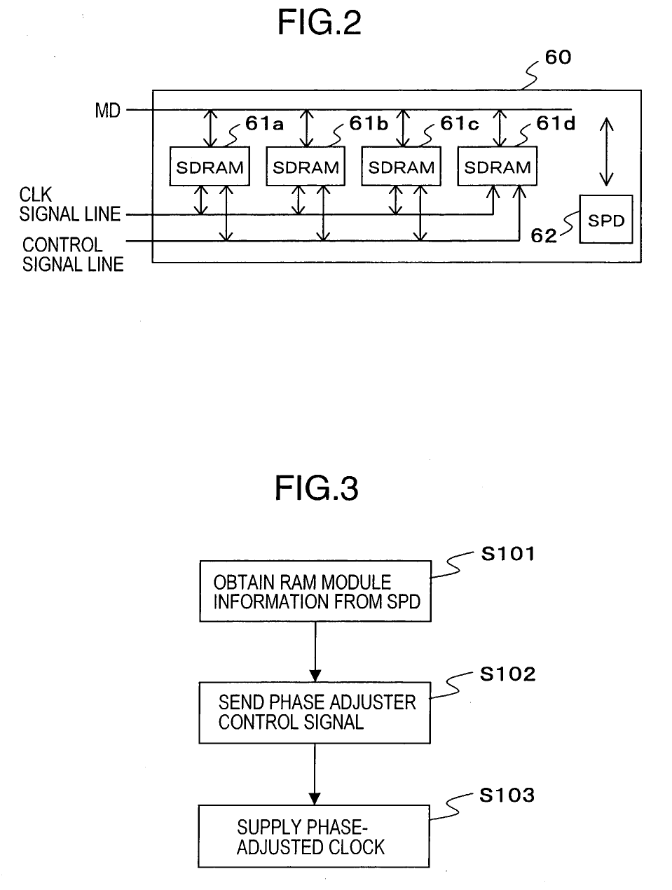

FIG. 2 is a view describing one example of the configuration of the RAM module 60. In the invention, the RAM module 60 may be designed as a general RAM module, for example, DIMM with a plurality of SDRAM chips mounted thereon.

The RAM module 60 is provided with a memory chip called an SPD 62 (Serial Presence Detect) which stores the information on the specification of the RAM module 60, in addition to a plurality of SDRAMs 61a to 61d connected to a memory data bus (MD), a clock signal line (CLK), and a control signal line.

The content stored in the SPD 62 may include, for example, memory module type identification information, a memory capacity, a bank structure, an operation clock of the installed memory, operation timing, the presence of parity bit, and so on.

The CPU 30 is designed to determine the memory capacity and the like of the installed RAM module 60 by obtaining the information from the SPD 62 of the RAM module 60 installed in the RAM socket.

Next, the information for adjusting the phase of a clock to be supplied to the RAM module 60, which is stored in the ROM 50, will be described.

The delay amount of the clock entered into the RAM module 60 varies depending on the load capacity of the RAM module 60. Therefore, the information for adjusting the phase of a clock can be the information in which the load capacity of the RAM module 60 installed in the RAM socket is brought into correspondence with the phase-adjusted value. Generally, since the load capacity corresponds to the memory capacity of the RAM module 60, it may be the information that the memory capacity is brought into correspondence with the phase-adjusted value. In this embodiment, since the memory capacity can be obtained by the SPD 62 easily, it is assumed that the information that the memory capacity is brought into correspondence with the phase-adjusted value is stored in the ROM 50. In this case, for example, when the RAM module 60 has the capacity of α MB, the information may include the content to the effect that the phase is delayed by β° as the adjusted value.

The adjusted value of a clock may be determined by using not only the phase of a clock but also the time; for example, in a way of delaying a clock by γ second. In this case, the phase adjuster 70 is enabled to change the delay time from the input to the output of a clock and the information to be stored in the ROM 50 is the information, for example, that the memory capacity is brought into correspondence with the delay time of a clock.

The adjusted value of the phase or the delay time has been previously required by the experiment and the like and stored in the ROM 50.

Next, the operation of the controller in the embodiment will be described with reference to the flow chart of FIG. 3.

At the activation and the like of the controller, the CPU 30 uses the SPD bus through the memory controller 40 and gains access to the SPDs 62a and 62b of the RAM modules 60a and 60b installed in the RAM sockets so as to obtain the respective SPD information (S101).

The respective adjusted values corresponding to the respective memory capacities of the RAM modules 60a and 60b included in the obtained SPD information are obtained from the ROM 50. Each signal for controlling the phase adjusters so as to get the respective adjusted values is sent to the phase adjusters 70c and 70d (S102).

Clocks phase-adjusted by the phase adjusters 70c and 70d are respectively supplied to the RAM modules 60a and 60b (S103).

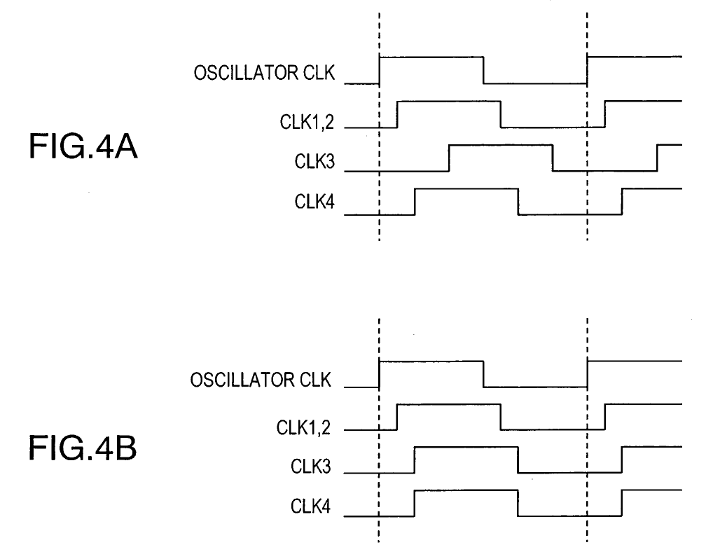

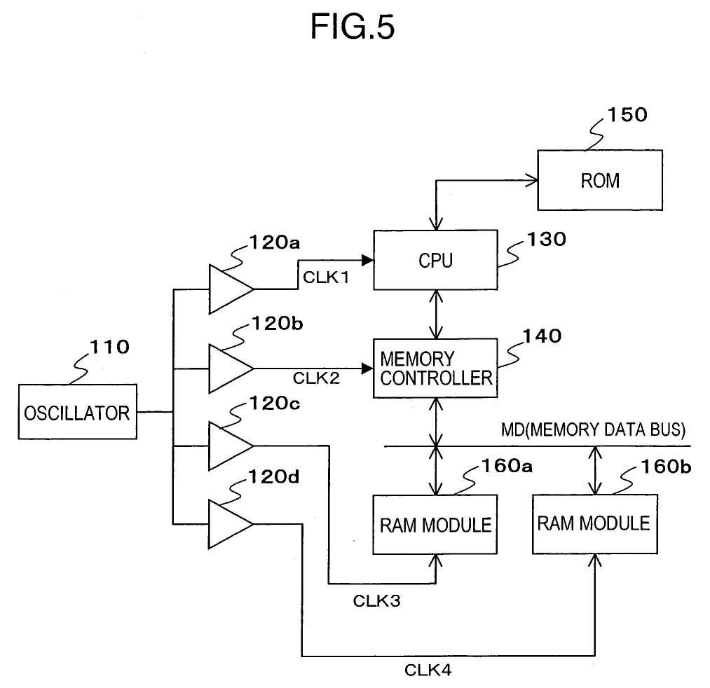

This results in improving the timing deviation between the CLK1 supplied to the CPU 30, the CLK2 supplied to the memory controller 40, the CLK3 supplied to the RAM module 60a, and the CLK4 supplied to the RAM module 60b. FIG. 4B is a view indicating each clock to be supplied to each chip at this time. In this figure, the CLK3 supplied to the RAM module 60a, which has been delayed in FIG. 4A, is adjusted and the clock skew decreases.

Thus, since the invention can adjust the timing of a clock by the phase adjuster, in accordance with the memory capacity of the RAM module 60, the controller of the electronic equipment such as a printer can adjust a clock skew as for the RAM module easily.

What is claimed is:

1. A controller for controlling a printer, comprising
an oscillator for generating a clock,
a CPU that is a destination of a clock and a RAM socket for installing a RAM module that is a destination of a clock,
a ROM which stores information for controlling the controller, and
an adjuster for adjusting a timing of the clock to be supplied to the RAM module installed in the RAM socket, wherein
the CPU obtains information about the RAM module from the RAM module installed in the RAM socket, and
controls the adjuster, in accordance with an adjusted value of the clock to be supplied to the RAM module, which is determined by the obtained information about the RAM module and the information stored in the ROM, so as to adjust the timing of the clock to be supplied to the RAM module.

2. The controller, according to claim 1, wherein
the information about the RAM includes a memory capacity of the RAM module, and
the information stored in the ROM includes information in which a memory capacity of the RAM module is brought into correspondence with the adjusted value of a clock to be adjusted.

3. The controller, according to claim 1 or 2, wherein
the adjusted value of a clock is represented by a phase of a clock.

4. The controller, according to claim 1 or 2, wherein
the adjusted value of a clock is represented by delay time of a clock.

5. The controller, according to any one of claims 1 to 4, wherein
a plurality of the RAM sockets are provided, and
timing adjustment of a clock to be supplied to the RAM module is performed on each RAM module installed in the RAM sockets.

6. A method for adjusting a clock skew caused by a difference of respective load capacities of a plurality of chips operated in synchronization with a clock, comprising
a step of obtaining information corresponding to the load capacity of a chip whose skew is to be adjusted, and
a step of adjusting a phase of a clock to be supplied to the chip, in accordance with the obtained information corresponding to the load capacity.

7. The method for adjusting a clock skew, according to claim 6, wherein
the chip whose skew is to be adjusted is the RAM module.

8. The method for adjusting a clock skew, according to claim 7, wherein
when there are a plurality of the RAM modules, the skew is adjusted for each RAM module.

9. A controller for controlling an electronic equipment, comprising
an oscillator for generating a clock,
a CPU that is a destination of a clock and a RAM socket for installing a RAM module that is a destination of a clock,
a ROM which stores information for controlling the controller, and
an adjuster for adjusting a timing of the clock to be supplied to the RAM module installed in the RAM socket, wherein
the CPU obtains information about the RAM module from the RAM module installed in the RAM socket, and
controls the adjuster, in accordance with an adjusted value of the clock to be supplied to the RAM module, which is determined by the obtained information about the RAM module and the information stored in the ROM, so as to adjust the timing of the clock to be supplied to the RAM module.
